(19) United States
(12) Patent Application Publication
(10) Pub. No.: US 2014/0083454 A1
(43) Pub. Date: Mar. 27, 2014

(54) METHOD FOR REMOVING FOREIGN PARTICLES ADHERED TO MOLDS

(71) Applicant: FUJIFILM Corporation, Tokyo (JP)

(72) Inventors: Satoshi WAKAMATSU, Haibara-gun (JP); Tadashi OMATSU, Haibara-gun (JP)

(73) Assignee: FUJIFILM Corporation, Tokyo (JP)

(21) Appl. No.: 14/034,789

(22) Filed: Sep. 24, 2013

Related U.S. Application Data
(63) Continuation of application No. PCT/JP2012/058766, filed on Mar. 26, 2012.

(30) Foreign Application Priority Data
Mar. 25, 2011 (JP) 2011-067553

(51) Int. Cl. B29C 33/72

(52) U.S. Cl. CPC B29C 33/722
USPC 134/4

(57) ABSTRACT

Positions on a mold at which foreign matter is present are detected, and adhered position information related to the positions is obtained. Corresponding position information related to positions on a substrate, which are positions that correspond to the positions of the foreign matter when a pattern of protrusions and recesses and a surface of the substrate on which a curable composition is coated face each other and undergo a predetermined positioning operation, is generated based on the adhered position information. At least one droplet of the curable composition is arranged at the positions of the substrate. The pattern of protrusions and recesses is pressed against the surface of the substrate on which the composition is coated while administering the predetermined positioning operation. The curable composition is cured, and the mold is separated from the cured composition. Thereby, foreign matter adhered to molds can be removed efficiently and at low cost.

### TECHNICAL FIELD

The present invention is related to a method for removing foreign particles adhered to the surface of a mold having a fine pattern of protrusions and recesses thereon.

### BACKGROUND ART

There are high expectations regarding utilization of pattern transfer techniques that employ a nanoimprinting method to transfer patterns onto resist coated on objects to be processed, in applications to produce magnetic recording media such as DTM (Discrete Track Media) and BPM (Bit Patterned Media) and semiconductor devices.

The nanoimprinting method is a development of the well known embossing technique employed to produce optical discs. In the nanoimprinting method, a mold (commonly referred to as a mold, a stamper, or a template), on which a pattern of protrusions and recesses is formed, is pressed against resist coated on a substrate, which is an object to be processed. Pressing of the original onto the resist causes the resist to mechanically deform or to flow, to precisely transfer the fine pattern. If a mold is produced once, nano level fine structures can be repeatedly molded in a simple manner. Therefore, the nanoimprinting method is an economical transfer technique that produces very little harmful waste and discharge. Therefore, there are high expectations with regard to application of the nanoimprinting method in various fields.

Conventionally, cleansing of such nanoimprinting molds is executed by cleansing methods which are utilized in the field of semiconductors, such as chemical cleansing using a combination of sulfuric acid and hydrogen peroxide, sulfuric acid, etc., physical cleansing using ultrasonic waves, and combinations of the two. However, the workability of chemical cleansing by the combination of sulfuric acid and hydrogen peroxide, sulfuric acid, etc. is poor because high concentration acids are utilized at high temperatures. Further, the cleansing performance of chemical cleansing is insufficient. In addition, there is a possibility that the cleansing fluid will corrode the pattern of protrusions and recesses. Meanwhile, there is a problem that physical cleansing using ultrasonic waves may cause defects in the fine pattern of protrusions and recesses. Defects in the patterns of protrusions and recesses become more significant as the patterns become finer.

It is necessary for nanoimprinting molds to transfer accurate patterns and to withstand several tens of thousands of nanoimprinting operations. Therefore, it is desired for nanoimprinting molds to be cleansed such that corrosion and defects in the fine structures of patterns of protrusions and recesses do not occur.

Japanese Unexamined Patent Publication No. 2005-353926 discloses a cleansing method that coats removing resin for removing resin, which is adhered onto a pattern of protrusions and recesses of a mold, onto the pattern of protrusions and recesses. The removing resin and the adhered resin are integrated, and then the removing resin is separated from the mold. K. Selenidis et al., “Defect Reduction Progress in Step and Flash Imprint Lithography”, Proceedings of SPIE, Vol. 6730, pp. 67300E-1-67300E-12, 2007 describes that during nanoimprinting employing the ink jet method, foreign particles that were adhered to a mold were removed after several nanoimprinting operations.

### DISCLOSURE OF THE INVENTION

However, the method of Japanese Unexamined Patent Publication No. 2005-353926 has as its premise that the resin adhered on the pattern of protrusions and recesses is integrated with the removing resin, and it is difficult to remove foreign particles other than those formed by resin. In addition, the removing resin is coated on the entirety of the mold, and there is a problem that the amount of utilized resin becomes great. Meanwhile, the method of Non Patent Document 1 is not that which has removal of foreign particles as its objective, and therefore the removal rate of foreign particles is low. In addition, in the method of K. Selenidis et al., “Defect Reduction Progress in Step and Flash Imprint Lithography”, Proceedings of SPIE, Vol. 6730, pp. 67300E-1-67300E-12, 2007, foreign particles on the mold are directly pressed against the surface of a substrate and become adhered to the substrate such that they are removed. Therefore, even if this method is applied to cleansing of molds, pressing forces will be concentrated at the portions of the mold to which foreign particles are adhered, and there is a possibility that fine structures of a pattern of protrusions and recesses will become damaged.

The present invention has been developed in view of the foregoing circumstances. It is an object of the present invention to provide a method for removing foreign particles adhered to molds that enables efficient removal of the foreign particles at low cost.

A method for removing foreign particles adhered to molds of the present invention that achieves the above object is a method for removing foreign particles adhered to a fine pattern of protrusions and recesses of a mold having the pattern of protrusions and recesses on the surface thereof, by causing the foreign particles to adhere to a curable composition coated on a substrate, characterized by comprising the steps of:

detecting positions on the mold at which the foreign particles are present to obtain adhered position information related to the adhered positions of the foreign particles;

generating corresponding position information related to positions on the substrate that correspond to the positions at which the foreign particles are present when the pattern of protrusions and recesses and a surface of the substrate on which the composition is coated face each other and undergo a predetermined positioning operation, based on the adhered position information;

arranging at least one droplet of the curable composition at the positions of the substrate corresponding to the positions at which the foreign particles are present, based on the corresponding position information;

pressing the mold against the curable composition in a state in which the pattern of protrusions and recesses and the surface of the substrate on which the composition is coated face each other while administering the predetermined positioning operation;

curing the curable composition; and

separating the mold from the cured composition.

In the present specification, the expression “arranging at least one droplet of the curable composition at the positions of the substrate corresponding to the positions at which the foreign particles are present” includes cases in which a single droplet is arranged to cover each corresponding position, cases in which one or more droplets are arranged in the vicinity of each corresponding position such that the corresponding position is not covered, and cases in which a single droplet is arranged to cover each corresponding position and one or more droplets are arranged in the vicinity of the corresponding position such that the corresponding position is not covered.

It is preferable for the method for removing foreign particles of the present invention to further comprise the steps of:

measuring the shapes of the foreign particles to obtain shape information related to the shapes of the foreign particles; and

increasing or decreasing the total amount of the at least one droplet based on the shape information.

In the method for removing foreign particles of the present invention, it is preferable for the total amount of the at least one droplet to be increased or decreased by increasing or decreasing the amount of the curable composition per droplet. Alternatively, it is preferable for the total amount of the at least one droplet to be increased or decreased by increasing or decreasing the droplet arranging density of the at least one droplet.

In the method for removing foreign particles of the present invention, it is preferable for the foreign particles to be formed by an organic material, and for the curable composition to contain a polymerizable compound having a molecular weight of 1000 or less.

Alternatively, it is preferable for the foreign particles to be formed by an inorganic material, and for the curable composition to contain a polymerizable compound having a functional group which is reactive with the surfaces of the foreign particles. In this case, it is preferable for the curable composition to contain 10% by weight or greater of a polyfunctional polymerizable compound having two or more of the functional groups.

In the method for removing foreign particles of the present invention, it is preferable for the foreign particles to be irradiated with ultrasonic waves after the pattern of protrusions and recesses is pressed against the surface on which the curable composition is coated and before the curable composition is cured.

In the method for removing foreign particles of the present invention, it is preferable for the curable composition to be a photocurable composition, and for the mold and/or the substrate to be heated after the pattern of protrusions and recesses is pressed against the surface on which the photocurable composition is coated and before the photocurable composition is cured.

In the method for removing foreign particles of the present invention, it is preferable for the space between the mold and the substrate to be depressurized.

In the method for removing foreign particles of the present invention, it is preferable for a plurality of droplets of the curable composition to be arranged on a region of the substrate corresponding to the pattern of protrusions and recesses such that a curable composition film is formed on the entirety of the region of the substrate without incomplete filling defects caused by gas bubbles when the pattern of protrusions and recesses is pressed against the surface of the substrate on which the curable composition is coated; and for the region of the substrate corresponding to the pattern of protrusions and recesses to be a region that corresponds to the pattern of protrusions and recesses when the pattern of protrusions and recesses and the surface of the substrate on which the composition is coated face each other and undergo a predetermined positioning operation.

In the method for removing foreign particles of the present invention, it is preferable for:

the pattern of protrusions and recesses to be a linear pattern of protrusions and recesses constituted by linear protrusions and linear recesses; and for

the droplets to be coated on the substrate such that the spaces among droplets in an A direction substantially parallel to the direction of the lines of the linear pattern of protrusions and recesses are longer than the spaces among droplets in a B direction substantially perpendicular to the A direction.

In the present specification, the expression “linear pattern of protrusions and recesses” refers to a pattern of protrusions and recesses that causes anisotropy to occur in the spreading directions of droplets such that the shapes of the droplets approximate ellipses when the pattern is pressed against the droplets, due to the shape of the pattern.

The expression “direction of the lines” refers to a direction in which spreading of the droplets is facilitated, from along the directions along the surface of the mold on which the pattern of protrusions and recesses is formed.

The expression “an A direction substantially parallel to the direction of the lines” includes directions, which are practically equal to the direction of the lines of the linear pattern of protrusions and recesses, within a range that enables obtainment of the operative effects of the present invention, in addition to the direction of the lines of the linear pattern of protrusions and recesses.

The expression “a direction substantially perpendicular to the A direction” includes directions, which are practically equal to the direction perpendicular to the A direction, within a range that enables the operative effects of the present invention to be obtained, in addition to the direction perpendicular to the A direction.

The expressions “spaces among droplets in an A direction” and “spaces among droplets in a B direction” refers to the distance in the A direction and in the B direction between a droplet and another droplet arranged remote from the droplet along the A direction or along the B direction. In the case that there are a plurality of other droplets, the space refers to a distance to the immediately adjacent droplet.

In the method for removing foreign particles of the present invention, it is preferable for a ratio Wa/Wb between an average space Wa between droplets in direction A and an average space Wb between droplets in direction B to satisfy the following inequality (1)

1.8≦Wa/Wb≦0.52V^{1/3}/d (1)

wherein V represents the average volume of each coated droplet, and d represents the average thickness of the curable composition film.

In the present specification, the expression “average space between droplets” along the A direction or the B direction refers to a value obtained by measuring the space between the central coordinates of a plurality of droplets arranged on the substrate within the line transfer region at at least two locations. In the case that the linear pattern of protrusions and recesses changes discontinuously, the line transfer region may be divided into regions in which the linear pattern of protrusions and recesses is continuous, and the average space between droplets may be calculated for each divided region. Differences occur between set values and actual values of spaces among droplets in the ink jet method, due to discharge performance of ink jet heads, compatibility between the properties of liquids and the surfaces of substrates, conditions (such as temperature) of the environment in which ink jet apparatuses are utilized, and the accuracy of XY scanning systems during ink jet drawing. Accordingly, there is a possibility that differences from settings set in the system of an ink jet printer will occur in the spaces among droplets in the A direction and the B direction, when arranging droplets on substrates by the ink jet method. Therefore, it is necessary to actually measure and adjust the spaces between the central coordinates of a plurality of droplets.

In the method for removing foreign particles of the present invention, it is preferable for the method by which the at least one droplet is arranged to be the ink jet method.

The method for removing foreign particles of the present invention detects foreign particle adhered positions, which are positions on the mold that represent the presence of foreign particles, and obtains adhered position information related to the foreign particle adhered positions. Then, corresponding position information related to positions on the substrate that correspond to the position at which the foreign particles are present when the pattern of protrusions and recesses and a surface of the substrate on which the composition is coated face each other and undergo a predetermined positioning operation is obtained, based on the adhered position information. Next, at least one droplet of the curable composition is arranged at each positions of the substrate corresponding to the position at which the foreign particles are present, based on the corresponding position information. Next, the mold is pressed against the curable composition in a state in which the pattern of protrusions and recesses and the surface of the substrate on which the composition is coated face each other while administering the predetermined positioning operation. Finally, the curable composition is cured, and the mold is separated from the cured composition. Thereby, a necessary amount of the curable resin can be accurately supplied to the corresponding positions, which are the positions at which the foreign particles are present when the pattern of protrusions and recesses and a surface of the substrate on which the composition is coated face each other and undergo the predetermined positioning operation. Accordingly, the curable composition is not wastefully consumed, and the probability that the foreign particles to be removed will be absorbed into the curable composition film is significantly increased. As a result, foreign particles can be efficiently removed from molds at low cost.

### BRIEF DESCRIPTION OF THE DRAWINGS

FIG. 1A is a sectional diagram that schematically illustrates a mold to be employed in a method for removing foreign particles according to an embodiment of the present invention.

FIG. 1B is a magnified view that illustrates across section of a portion of a patterned region of the mold of FIG. 1A.

FIG. 2A is a plan view that schematically illustrates a foreign particle adhered position on a mold.

FIG. 2B is a plan view that schematically illustrates a foreign particle corresponding position on a substrate.

FIG. 3 is a bottom view that schematically illustrates the foreign particle adhered position viewed from the bottom surface of the mold.

FIGS. 4A-4D are a collection of diagrams that schematically illustrate examples of manners in which at least one droplet is arranged at a foreign particle corresponding position.

FIGS. 5A-5E are a collection of diagrams that schematically illustrate example of linear patterns of protrusions and recesses and non linear patterns of protrusions and recesses.

FIGS. 6A-6C are a collection of diagrams that schematically illustrate the manner in which droplets, which are arranged on a transparent substrate, spread as a flat plate is pressed thereon.

FIGS. 7A-7C are a collection of diagrams that schematically illustrate the manner in which droplets, which are arranged on a transparent substrate, spread as a mold is pressed thereon.

FIGS. 8A-8C are a collection of diagrams that schematically illustrate the manner in which droplets, which are arranged on a transparent substrate taking the direction of lines into consideration, spread as a mold is pressed thereon.

FIG. 9 is a diagram that schematically illustrates a state in which circles are closely packed, taking the direction of lines into consideration.

FIG. 10 is a diagram that schematically illustrates the manner in which droplets spread, when a ratio between an average space between droplets Wa in an A direction and an average space between droplets Wb in a B direction and a ratio between the radii in the direction of the long axes and the radii in the direction of the short axes of elliptical shapes when the droplets are spread match.

FIG. 11 is a diagram that schematically illustrates the positional relationship between a foreign particle and at least one droplet when a pattern of protrusions and recesses and a surface coated with a composition face each other and undergo a predetermined positioning operation.

FIG. 12 is a diagram that schematically illustrates the manner in which a mold is pressed against a curable composition to forma curable composition film while administering a predetermined positioning operation in a state in which a pattern of protrusions and recesses and a surface coated with a composition face each other.

### BEST MODE FOR CARRYING OUT THE INVENTION

Hereinafter, embodiments of the present invention will be described with reference to the attached drawings. However, the present invention is not limited to the embodiments to be described below. Note that in the drawings, the dimensions of the constitutive elements are drawn differently from the actual dimensions thereof, in order to facilitate visual recognition thereof.

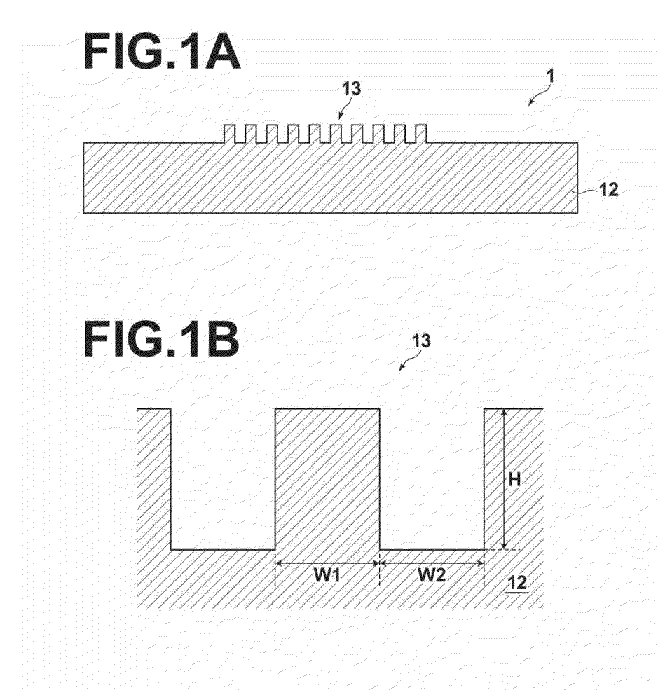

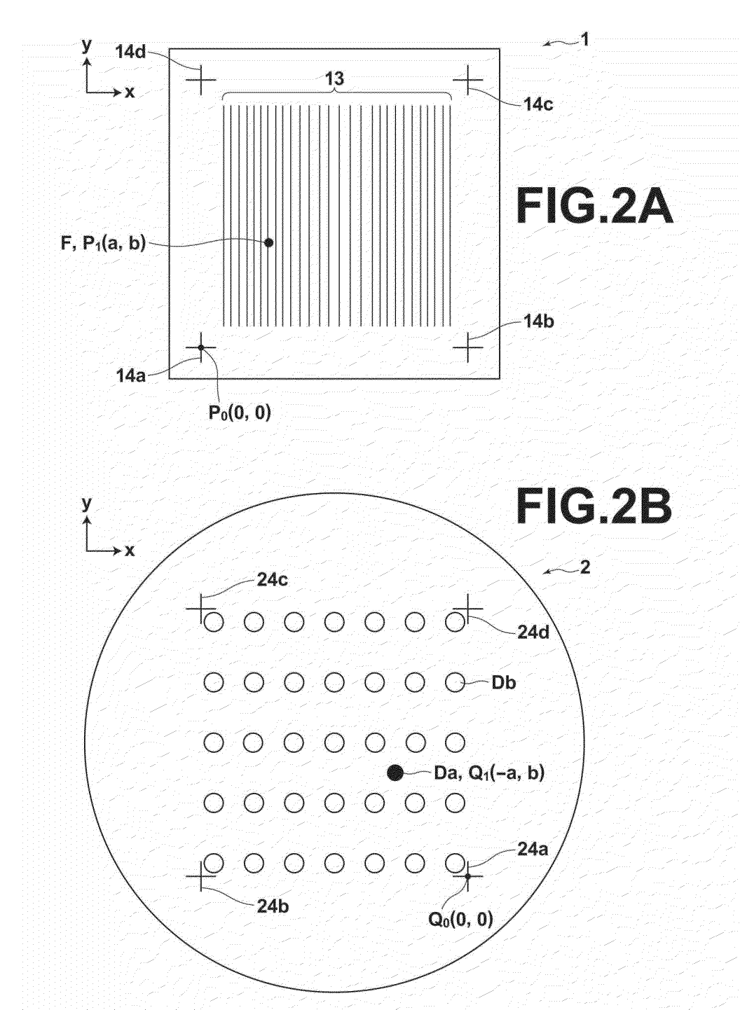

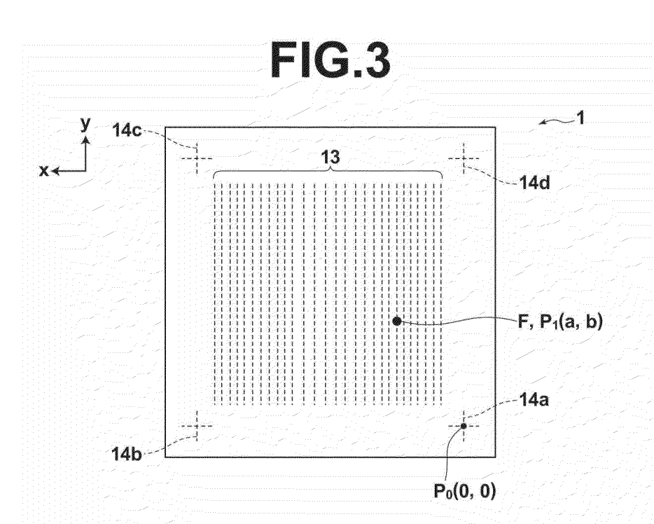

An embodiment of the method for removing foreign particles adhered to molds of the present invention will be described. FIG. 1A is a sectional diagram that schematically illustrates a mold to be employed in a method for removing foreign particles according to an embodiment of the present invention. FIG. 1B is a magnified view that illustrates a cross section of a portion of a patterned region of the mold of FIG. 1A. FIG. 2A is a plan view that schematically illustrates a foreign particle adhered position on a mold. FIG. 2B is a plan view that schematically illustrates a foreign particle corresponding position on a substrate. FIG. 3 is a bottom view that schematically illustrates the foreign particle adhered position viewed from the bottom surface of the mold.

A position P₁ on a mold 1, at which a foreign particle F is present is detected, and adhered position information related to the position P₁ is obtained. Corresponding position information related to a position Q₁ on a substrate 2 that corresponds to the position P₁ when a pattern 13 of protrusions and recesses and a surface of the substrate 2 on which a photocurable composition is coated face each other and undergo a predetermined positioning operation is generated, based on the adhered position information. At least one droplet Da of the photocurable composition is arranged at the position Q₁ of the substrate. The pattern 13 of protrusions and recesses is pressed against the surface of the substrate 2 on which the composition is coated while administering the predetermined positioning operation. The photocurable composition is cured, and the mold 1 is separated from the cured composition, to cause the foreign particle F to adhere to the photocurable composition coated on the substrate 2, thereby removing the foreign particle F.

### (Mold)

The mold 1 is constituted by a support portion 12, and a fine pattern 13 of protrusions and recesses which is formed on the surface of the support portion 12, as illustrated in FIG. 1A and FIG. 1B.

The material of the support portion 12 may be: a metal, such as silicon, nickel, aluminum, chrome, steel, tantalum, and tungsten; oxides, nitrides, and carbides thereof. Specific examples of the material of the support portion 12 include silicon oxide, aluminum oxide, quartz glass, Pyrex™, glass, and soda glass.

The shape of the pattern 13 of protrusions and recesses is not particularly limited, and may be selected as appropriate according to the intended use of the nanoimprinting mold. An example of a typical pattern is a line and space pattern as illustrated in FIG. 1A and FIG. 1B. The length of the lines (protrusions), the width W1 of the lines, the distance W2 among the lines, and the height H of the lines from the bottoms of the recesses (the depth of the recesses) are set as appropriate in the line and space pattern. For example, the width W1 of the lines is within a range from 10 nm to 100 nm, more preferably within a range from 20 nm to 70 nm, the distance W2 among the lines is within a range from 10 nm to 500 nm, more preferably within a range from 20 nm to 100 nm, and the height H of the lines is within a range from 10 nm to 500 nm, more preferably within a range from 30 nm to 100 nm. In addition, the shapes of the protrusions that constitute the pattern 13 of protrusions and recesses may be dots having rectangular, circular, or elliptical cross sections.

The mold 1 may be produced by the following procedures, for example. First, a Si substrate is coated with a photoresist liquid having acrylic resin as its main component such as a novolac resin or an acrylic resin such as PMMA (polymethyl methacrylate) by the spin coat method or the like, to form a photoresist layer. Next, a laser beam (or an electron beam) is irradiated onto the Si substrate while being modulated according to a desired pattern of protrusions and recesses, to expose the pattern on the surface of the photoresist layer. Then, the photoresist layer is developed to remove the exposed portions. Finally, selective etching is performed by RIE or the like, using the photoresist layer after the exposed portions are removed as a mask, to obtain the mold having a predetermined pattern of protrusions and recesses.

The mold 1 may undergo a mold release process to improve separation properties between the photocuring resin and the mold. It is preferable for the mold release process to be performed employing a silicone or fluorine silane coupling agent. Commercially available mold release agents such as Optool DSX by Daikin Industries, ltd. and Novec EGC-1720 by Sumitomo 3M Limited may be favorably employed.

### (Foreign Particles to be Removed)

The foreign particles F to be removed by the present invention differs according to the cleanliness of the space in which nanoimprinting is executed, the cleanliness of the substrate 2 which is utilized, the cleanliness of a curable composition, and the methods for handling the mold 1 and the substrate 2. For example, typical pieces of foreign particles F that become adhered to a mold during nanoimprinting are inorganic compounds such as NaCl and KCl (components included in human sweat), inorganic Si material such as Si and SiO₂ (pieces of the mold 1 or the substrate 2), organic materials, and various pieces of dust from the environment. Examples of the organic particles include pieces of carrying cases of the mold 1 or the substrate 2, pieces of handling equipment, and pieces of holding members formed by organic materials, as well as proteins such as human hair and skin. The size of the foreign particles may vary. The range of sizes for foreign particles to be removed by the present invention is 100 μm or less, more preferably 10 μm or less, and most preferably 5 μm or less. In the case that foreign particles F having a size greater than 100 μm is to be removed, it is favorable to select cleansing with a solution, in order to avoid damage to fine structures of the pattern 13 of protrusions and recesses.

### (Method for Obtaining Information Regarding Foreign Particles Adhered to Molds)

The method by which the adhered position information and shape information related to foreign particles F adhered to the mold 1 is not particularly limited. Measuring devices, such as a surface defect examining device, an SEM (Scanning Electron Microscope), an AFM (Atomic Force Microscope), an optical microscope, and a laser microscope may be employed. Adhered position information and shape information related to the foreign particles F are obtained, and reflected in the arrangement position of the at least one droplet and the total amount of the at least one droplet. The adhered position information may be obtained as relative coordinates from the outer peripheral portion of the mold. In this case, the relative coordinates are coordinates relative to the four corners of the mold if the mold is rectangular, and coordinates relative to the orientation flat end (notch) of the mold if the mold is a wafer. Alternatively, marks (alignment marks, for example) which are capable of being discerned by the aforementioned measuring devices may be formed on the mold 1 in advance, and coordinates relative to the marks may be obtained. The shape information refers to the area occupied by the foreign particles F and the shape of the contour of the foreign particles F when the mold 1 is viewed from above (the upper direction in FIG. 1A), the height of the foreign particles F from the surface of the mold 1, and the like.

### (Foreign Particle Adhered Positions)

The “foreign particle adhered positions” that represent the presence of the foreign particles F on the mold 1 may be representative points extracted from projected regions when the shapes of the foreign particles F are projected onto the mold 1 from above. The adhered position information related to the foreign particle adhered positions P₁ is that which specifies the positions of the foreign particles F with respect to a reference point P₀, as illustrated in FIG. 2A. In FIG. 2A, for example, an alignment mark 14a is designated as the reference point P₀, an xy plane is defined on the mold 1, and a position P₁ at which the foreign particle F is present is expressed as coordinates on the xy plane.

### (Substrate)

A quartz substrate is preferred to enable the photocurable composition to be exposed to light in the case that a Si mold, which is not light transmissive, is employed. The quartz substrate is not particularly limited as long as it has light transmissive properties and has a thickness of 0.3 mm or greater, and may be selected as appropriate according to intended use. It is preferable for the surface of the quartz substrate to be coated with a silane coupling agent.

In addition, the expression “light transmissive properties” refers to a degree of light transmissivity that enables sufficient curing of the photocuring resin film when light enters the side of the substrate opposite that on which the photocuring resin film is formed. Specifically, the “light transmissive properties” refers to light transmissivity of 5% or greater with respect to light having wavelengths of 200 nm or greater from the side of the substrate opposite that on which the photocuring resin film is formed to the side of the substrate on which the photocuring resin film is formed.

It is preferable for the thickness of the quartz substrate to be 0.3 mm or greater. If the thickness of the quartz substrate is less than 0.3 mm, it is likely to become damaged during handling or due to pressure during imprinting.

Meanwhile, substrates to be employed with the quartz mold are not limited with regard to the shape, the structure, the size or the material thereof, and may be selected according to intended use. With respect to the shape of the substrate, a substrate having a discoid shape may be utilized in the case that nanoimprinting is performed to produce a data recording medium. With respect to the structure of the substrate, a single layer substrate may be employed, or a laminated substrate may be employed. With respect to the material of the substrate, the material may be selected from among known materials for substrates, such as silicon, nickel, aluminum, glass, and resin. These materials may be utilized singly or in combination. The substrate may be produced, or may be those which are commercially available. The thickness of the substrate is not particularly limited, and may be selected according to intended use. However, it is preferable for the thickness of the substrate to be 0.05 mm or greater, and more preferably 0.1 mm or greater. If the thickness of the substrate is less than 0.05 mm, there is a possibility that the substrate will flex during close contact with the mold, resulting in a uniform close contact state not being secured.

A surface of the substrate 2, on which the at least one droplet Da of the curable composition to be described later is arranged, is designated as a composition arrangement surface. The substrate 2 has alignment marks 24a through 24d such that the predetermined positioning operation can be performed in a state in which the pattern 13 of protrusions and recesses faces the composition arrangement surface as illustrated in FIG. 2B.

### (Foreign Particle Corresponding Positions)

The foreign particle corresponding positions Q₁ on the substrate 2 are positions that correspond to the foreign particle adhered positions P₁ when the pattern 13 of protrusions and recesses and the composition arrangement surface of the substrate 2 face each other and undergo the predetermined positioning operation. The corresponding position information is that which specifies the foreign particle corresponding positions Q₁ with respect to a reference point Q₀, as illustrated in FIG. 2B. In FIG. 2B, for example, the alignment mark 24a is designated as the reference point Q₀, an xy plane is defined on the mold 1, and the foreign particle corresponding position Q₁ is expressed as coordinates on the xy plane. The predetermined positioning operation is the same positioning operation which is actually performed when the mold 1 is pressed against the curable composition. For example, as illustrated in FIG. 3, the mold 1 is rotated 180° about a certain y axis as the rotational axis, to align the alignment marks 14a, 14b, 14c, and 14d on the mold 1 with the alignment marks 24a, 24b, 24c, and 24d on the substrate 2. Accordingly, in the case that the coordinates of the foreign particle adhered position P₁ are (a, b), the coordinates of the foreign particle corresponding position Q₁ will be (−a, b). Note that a case has been described above in which the reference point on the mold 1 and the reference point on the substrate 2 assume a corresponding relationship when the pattern of protrusions and recesses and the composition arrangement surface face each other. However, it is not necessary for the reference points to correspond to each other as long as the positional relationship therebetween is known.

### (Curable Composition)

A photocurable composition or a heat curable composition may be employed as the curable composition. However, a photocurable composition is particularly preferred.

The photocurable composition is not particularly limited. In the present embodiment, a photocurable composition prepared by adding a photopolymerization initiator (2% by mass) and a fluorine monomer (0.1% by mass to 1% by mass) to a polymerizable compound may be employed. An antioxidant agent (1% by mass) may further be added as necessary. The photocurable composition produced by the above procedures can be cured by ultraviolet light having a wavelength of 360 nm. With respect to resins having poor solubility, it is preferable to add a small amount of acetone or acetic ether to dissolve the resin, and then to remove the solvent.

In the case that the foreign particles are organic materials, it is preferable for the curable composition to contain a polymerizable compound having a molecular weight of 1000 or less. The removal efficiency with respect to foreign particles can be improved by the curable composition containing a polymerizable compound constituted by components having molecular weights of 1000 or less. This is because the effect of separating the foreign particles from the mold is improved by permeation of the low molecular weight polymerizable compound into the interior of the organic foreign particles and into the close contact space between the foreign particles and the mold being facilitated. In addition, the affinity between the surfaces of the foreign particles and the polymerizable compound is increased if the curable compound contains hetero elements such as O, N, and S. If the affinity is increased, the adhesive force that acts between the foreign particles and the curable composition increases, and the effect of separating the foreign particles from the mold is further improved. In addition, if the curable composition contains components having functional groups that react with the surfaces of the foreign particles, the adhesive force that acts between the foreign particles and the curable composition increases, and the effect of separating the foreign particles from the mold is further improved.

On the other hand, in the case that the foreign particles are inorganic materials, it is preferable for the curable composition to contain a polymerizable compound that has functional groups that react with the surfaces of the foreign particles. Thereby, the removal efficiency with respect to the inorganic foreign particles can be improved. It is preferable for the curable composition to contain functional groups that react with the inorganic material on the surfaces of the foreign particles, reactive groups having radical polymerizing properties or cationic polymerizing properties that react with the polymerizable compound in the curable composition, or a coupling agent having reactive groups such as isocyanate groups and carbonate groups that react with hydroxyl groups, thiol groups, or amino groups within the curable composition at 0.1% by mass to 20% by mass. Specific examples of such a coupling agent include: KBM503, KBM5103, KBM403, KBM9103, and KBM9007 (all by Shin-Etsu Chemical co., Ltd.).

It is preferable for the polymerizable compound to contain 10% by weight or greater of a polyfunctional polymerizable compound having two or more of the functional groups. The rigidity of the curable composition film after curing will increase by the polymerizable compound containing the polyfunctional polymerizable compound, thereby enabling more positive separation of the cured film which has captured the foreign particles F.

Examples of the polymerizable compound include: benzyl acrylate (Viscoat #160 by Osaka Organic Chemical Industry Ltd.), ethyl carbitol acrylate (Viscoat #190 by Osaka Organic Chemical Industry Ltd.), polypropylene glycol diacrylate (Aronix M-220 by TOAGOSEI Co., Ltd.), and trimethylol propane PO denatured triacrylate (Aronix M-310 by TOAGOSEI Co., Ltd.). In addition, a compound A represented by the following chemical formula 1 may also be employed as the polymerizable compound.

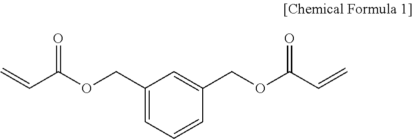 [SMILES: C=CC(=O)OCc1cccc(COC(=O)C=C)c1]

Examples of the photopolymerization initiating agent include alkyl phenone type photopolymerization initiating agents, such as 2-(dimethyl amino)-2-[(4-methylphenyl) methyl]-1-[4-(4-morpholinyl) phenyl]-1-butanone (IRGACURE 379 by Toyotsu Chemiplas Corporation.)

In addition, a compound B represented by the following chemical formula 2 may be employed as the fluorine monomer.

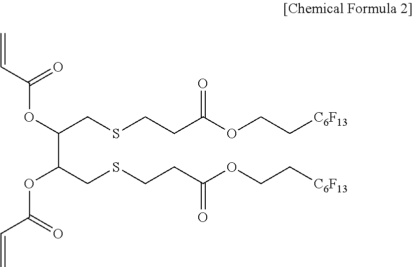

In the present invention, the viscosity of the resist material is within a range from 8 cP to 20 cP, and the surface energy of the resist material is within a range from 25 mN/m to 35 mN/m. Here, the viscosity of the resist material was measured by a RE-80L rotating viscosity meter (by Toki Sangyo Co., Ltd.) at 25±0.2° C.°. The rotating speeds during measurements were: 100 rpm at viscosities greater than or equal to 0.5 cP and less than 5 cP; 50 rpm at viscosities greater than or equal to 5 cP and less than 10 cP; 20 rpm at viscosities greater than or equal to 10 cP and less than 30 cP; and 10 rpm at viscosities greater than or equal to 30 cP and less than 60 cP. The surface energy of the resist material was measured using the technique disclosed in H. Schmitt et al., “UV nanoimprint materials: Surface energies, residual layers, and imprint quality”, J. Vac. Sci. Technol. B., Vol. 25, No. 3, pp. 785-790, 2007. Specifically, the surface energies of Si substrates that underwent UV ozone processes and the surface of which were treated with Optool DSX (by Daikin Industries, ltd.) were measured, then the surface energy of the resist material was calculated from the contact angles thereof with respect to the substrates.

### (Method for Arranging Droplets)

The droplets are arranged by coating predetermined positions of the substrate with droplets having predetermined droplet amounts (an amount per each single arranged droplet) utilizing the ink jet method or the dispensing method.

When the droplets of the curable composition are arranged on the substrate 2, an ink jet printer or a dispenser may be used according to the desired droplet amounts. For example, in the case that the droplet amount is less than 100 nl, the ink jet printer may be selected, and in the case that the droplet amount is 100 nl or greater, the dispenser may be selected.

Examples of ink jet heads that expel the curable composition from nozzles include the piezoelectric type, the thermal type, and the electrostatic type. From among these, the piezoelectric type of ink jet head, in which the droplet amount (the amount of each arranged droplet) and the expulsion speed are adjustable, is preferable. The amount of droplet amount and the expulsion speed are set and adjusted prior to arranging the droplets of the curable composition onto the substrate 2. For example, it is preferable for the droplet amount to be adjusted to be greater at regions at which the spatial volume of the foreign particles F is judged to be large based on the shape information related to the foreign particles F, and to be smaller at regions at which the spatial volume of the foreign particles F is small or when coating is performed onto regions at which foreign particles are not present. Such adjustments are controlled as appropriate according to droplet expulsion amounts (the amount of each expelled droplet). Specifically, in the case that the droplet amount is set to 5 pl, an ink jet head having a droplet expulsion amount of 1 pl is controlled to expel droplets onto the same location 5 times. In the present invention, the droplet amount is within a range from 1 pl to 10 pl. The droplet amount is obtained by measuring the three dimensional shapes of droplets arranged on a substrate under the same conditions with a confocal microscope or the like, and by calculating the volumes of the droplets from the shapes thereof.

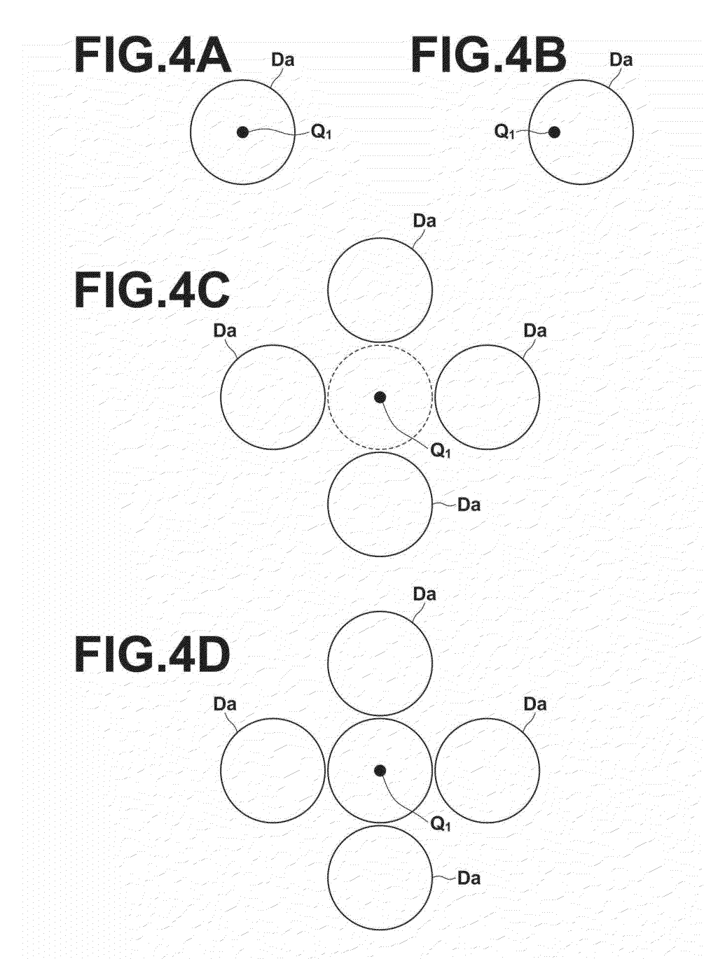

In the present application, the at least one droplet Da is arranged at each foreign particle corresponding position Q₁. The expression “at least one droplet” refers to a single droplet or a group of droplets constituted by two or more droplets arranged at each foreign particle corresponding position and/or the vicinity thereof, in order to surround and envelope the foreign particles. The arrangement position and the droplet amount on the substrate 2 of the at least one droplet Da are adjusted based on the adhered position information and the shape information obtained with respect to the foreign particles F. Further, it is preferable for the droplet arrangement density on the substrate 2 in the vicinity of the foreign particle corresponding positions to be adjusted such that the foreign particle F can be surrounded and enveloped, based on the shape information thereof. FIG. 4 is a collection of diagrams that schematically illustrate examples of manners in which the at least one droplet Da is arranged at the foreign particle corresponding position Q₁. Specific examples of the manners in which the at least one droplet Da is arranged at the foreign particle corresponding position Q₁ include: arranging a single droplet Da such that the center of the droplet matches the center of the foreign particle corresponding position Q₁ (FIG. 4A); and arranging a single droplet Da such that the center of the droplet does not match the center of the foreign particle corresponding position Q₁ (FIG. 4B). In addition, the at least one droplet may be arranged only in the vicinity of the foreign particle corresponding position Q₁ in order to adjust the droplet arrangement density according to the shape and size of the foreign particle (FIG. 4C), or a single droplet may be arranged such that the outer edge of the droplet surrounds the foreign particle corresponding position Q1 and at least one droplet may further be arranged in the vicinity of the foreign particle corresponding position Q₁ (FIG. 4D).

In addition, it is preferable for a plurality of droplets of the curable composition being arranged on a region of the substrate 2 corresponding to the pattern of protrusions and recesses such that a curable composition film is formed on the entirety of the region of the substrate without incomplete filling defects caused by gas bubbles when the mold 1 is pressed against the composition arrangement surface of the substrate. The expression “plurality of droplets” refers to a group of droplets constituted by two or more droplets which are arranged in the region of the substrate 2 corresponding to the pattern of protrusions and recesses with the objective of forming the curable composition film. Note that the “at least one droplet” and the “plurality of droplets” are not clearly distinguished, and there are droplets which are both the “at least one droplet” and one of the “plurality of droplets”. The region of the substrate corresponding to the pattern of protrusions and recesses being a region that corresponds to the pattern of protrusions and recesses when the pattern of protrusions and recesses and the surface of the substrate on which the composition is coated face each other and undergo a predetermined positioning operation. If incomplete filling defects caused by gas bubbles are formed in the curable composition film, the curable composition in the vicinities of the incomplete filling defects will become adhered to the recesses of the pattern 13 of protrusions and recesses, and there is a possibility that the adhered curable composition will remain as residue after the mold is separated from the curable composition. Formation of the incomplete filling defects caused by gas bubbles can be suppressed throughout the region corresponding to the pattern by adopting the above technique.

After the droplet amount is adjusted as described above, the droplets are arranged onto the substrate according to a predetermined droplet arrangement pattern. The droplet arrangement pattern is constituted by two dimensional coordinate information that includes lattice point groups corresponding to the droplet arrangement to be coated on the substrate.

### (Droplet Arrangement for Linear Patterns of Protrusions and Recesses)

In the case that the plurality of droplets are to be arranged on the region of the substrate corresponding to the pattern and the pattern of protrusions and recesses is a linear pattern of protrusions and recesses constituted by linear protrusions and linear recesses, it is preferable for the plurality of droplets to be arranged such that the spaces among droplets in an A direction substantially parallel to the direction of the lines of the linear pattern of protrusions and recesses are longer than the spaces among droplets in a B direction substantially perpendicular to the A direction. Here, the expression “an A direction substantially parallel to the direction of the lines” includes directions, which are practically equal to the direction of the lines of the linear pattern of protrusions and recesses, within a range that enables obtainment of the operative effects of the present invention, in addition to the direction of the lines of the linear pattern of protrusions and recesses. Preferably, the expression refers to directions within an angular range of ±30° from the direction of the lines, and more preferably to directions within an angular range of ±15° from the direction of the lines. Meanwhile, the expression “a direction substantially perpendicular to the A direction” includes directions, which are practically equal to the direction perpendicular to the A direction, within a range that enables the operative effects of the present invention to be obtained, in addition to the direction perpendicular to the A direction. Preferably, the expression refers to directions within an angular range of ±30° from the direction perpendicular to the A direction, and more preferably to directions within an angular range of ±15° from the direction perpendicular to the A direction.

As described previously, the expression “linear pattern of protrusions and recesses” refers to a pattern of protrusions and recesses that causes anisotropy to occur in the spreading directions of droplets such that the shapes of the droplets approximate ellipses when the pattern is pressed against the droplets, due to the shape of the pattern. A pattern of protrusions and recesses that causes the long axes of the elliptical shapes of the plurality of droplets to be oriented in a single direction when the pattern is pressed against the droplets is referred to as a “straight linear pattern of protrusions and recesses”.

As described previously, the expression “direction of the lines” of the linear pattern of protrusions and recesses refers to a direction in which spreading of the droplets is facilitated, from along the directions along the pattern formation surface of the mold. In other words, the expression “direction of the lines of the linear pattern of protrusions and recesses” refers to a direction along the long axes of the plurality of ellipses that the droplets approximate when the linear pattern of protrusions and recesses is pressed against the droplets. In addition, the “linear direction” of the straight linear pattern of protrusions and recesses refers to a constant direction of the lines from among the directions of the long axes of a plurality of ellipses.

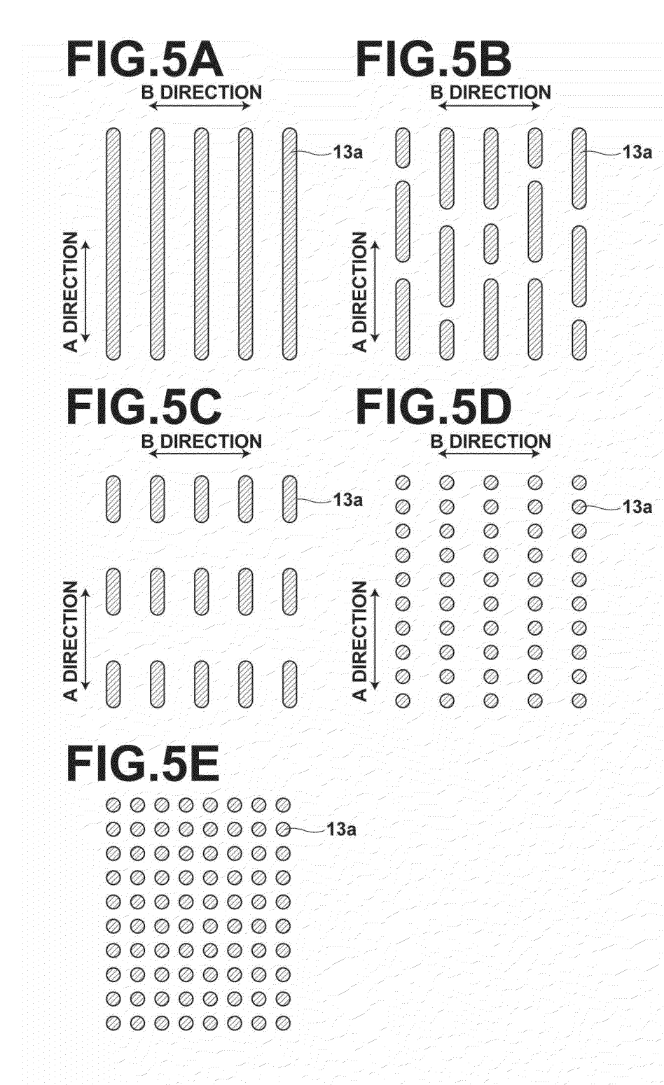

FIGS. 5A through 5D are diagrams that schematically illustrate examples of linear patterns of protrusions and recesses. FIG. 5A, FIG. 5B, and FIG. 5C are schematic diagrams that illustrate patterns of protrusions and recesses of the line and space type, in which elongated protrusions 13a are arranged parallel to each other. FIG. 5D is a schematic diagram that illustrates a pattern, in which rows of dot shaped protrusions 13a, which are densely arranged in a single direction, are arranged parallel to each other. In these patterns, it is easier for the coated droplets to spread within spaces between the protrusions 13a. Therefore, anisotropy occurs in the spreading of the droplets, and the shapes of the spread droplets approximate ellipses. Accordingly, the direction of the lines is a direction along the length direction of the elongate protrusions, or a direction along the length direction of the rows of densely arranged dot shaped protrusions. FIG. 5A through FIG. 5D illustrate cases in which the protrusions 13a are formed and/or arranged as straight lines. However, the linear patterns are not limited to straight linear patterns, and the linear patterns may be formed or arranged such that they curve and/or zigzag. Note that FIG. 5E is a diagram that schematically illustrates a pattern in which dot shaped protrusions 13a are uniformly arranged in both vertically and horizontally. Because anisotropy does not clearly occur in the spreading direction of droplets, such a pattern is not a linear pattern of protrusions and recesses as defined in the present specification.

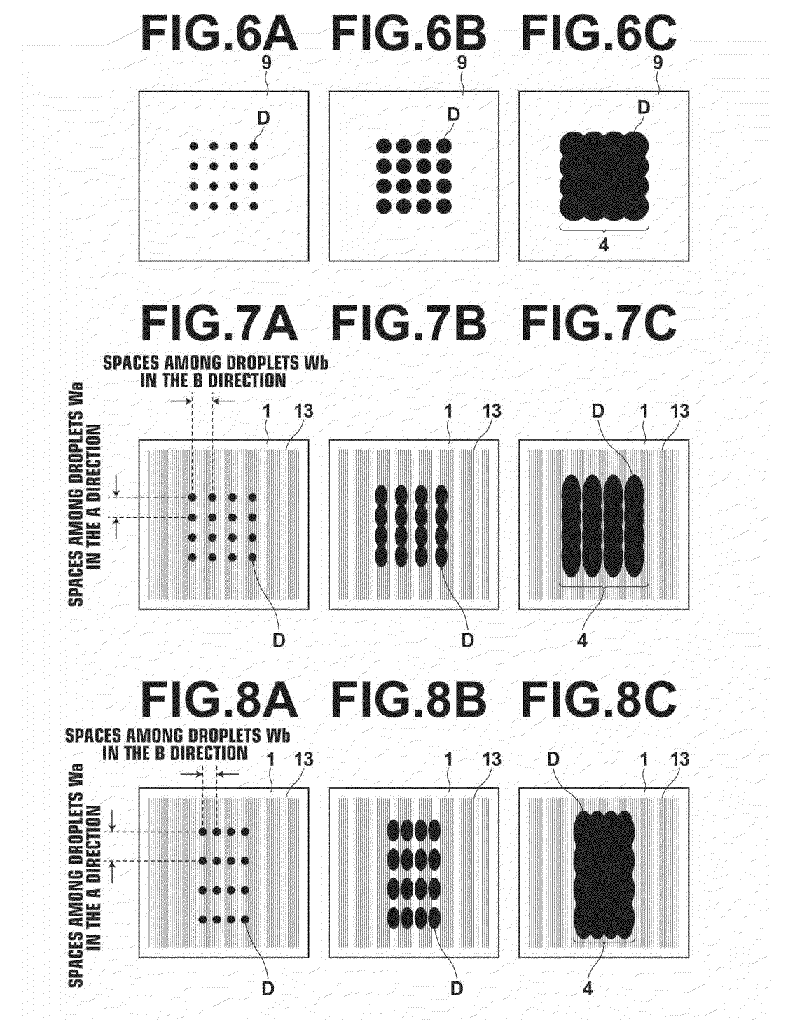

The droplet arrangement pattern described above takes the fact that anisotropy occurs in the spreading direction of the droplets along the direction of the lines of the linear pattern of protrusions and recesses into consideration. For example, FIG. 6 is a collection of diagrams that schematically illustrate the manner in which droplets D, which are uniformly arranged on a transparent substrate such as a quartz substrate, spread as a flat plate 9 without a pattern of protrusions and recesses thereon is pressed against the substrate. FIG. 7 is a collection of are diagrams that schematically illustrate the manner in which droplets D, which are uniformly arranged on a transparent substrate, spread as a mold 1 having a straight linear pattern of protrusions and recesses 13 is pressed thereon. In the case illustrated in FIG. 6, the droplets D spread isotropically. Therefore, no problems occur if the arrangement of the droplets D does not take the vertical and horizontal directions into consideration, and a curable composition film 4 can be formed by the uniformly arranged droplets D. However, in the case illustrated in FIG. 7, the droplets D spread anisotropically. Therefore, if the amounts of resist in the droplets are the same, it is necessary to take the straight line direction A into consideration. That is, if the spaces among droplets Wa in the A direction and the spaces among droplets Wb in the B direction are equal, the amount of the droplets D in the A direction, in which it is easy for the droplets D to spread, will become excessive, and fluctuations will occur in the thickness of the curable composition film 4. At the same time, there will be an insufficient amount of the droplets D in the B direction, in which it is not easy for the droplets D to spread, and there is a possibility that defects due to residual gas will occur in the curable composition film 4. Therefore, the present invention takes the direction of the lines of the pattern of protrusions and recesses, that is, the ease and difficulty in the spreading of the droplets D, into consideration in the case that the mold 1 having the straight linear pattern 13 of protrusions and recesses is employed. Specifically, the arrangement of the droplets D is set such that the spaces among droplets Wa in the A direction are wide and the spaces among droplets Wb in the B direction are narrow, as illustrated in FIG. 8. Thereby, fluctuations in the thickness of the resist film 4 and faults due to residual gas are suppressed compared to cases in which the straight line direction A is not taken into consideration.

It is preferable for a ratio Wa/Wb between an average space Wa between droplets in direction A and an average space Wb between droplets in direction B to satisfy the following inequality (1)

1.8≦Wa/Wb≦0.52V^{1/3}/d (1)

In formula (1), V represents the average volume of each coated droplet, and d represents a target average thickness of the resist film (including residual film), onto which the pattern of protrusions and recesses is transferred following the spreading of the droplets.

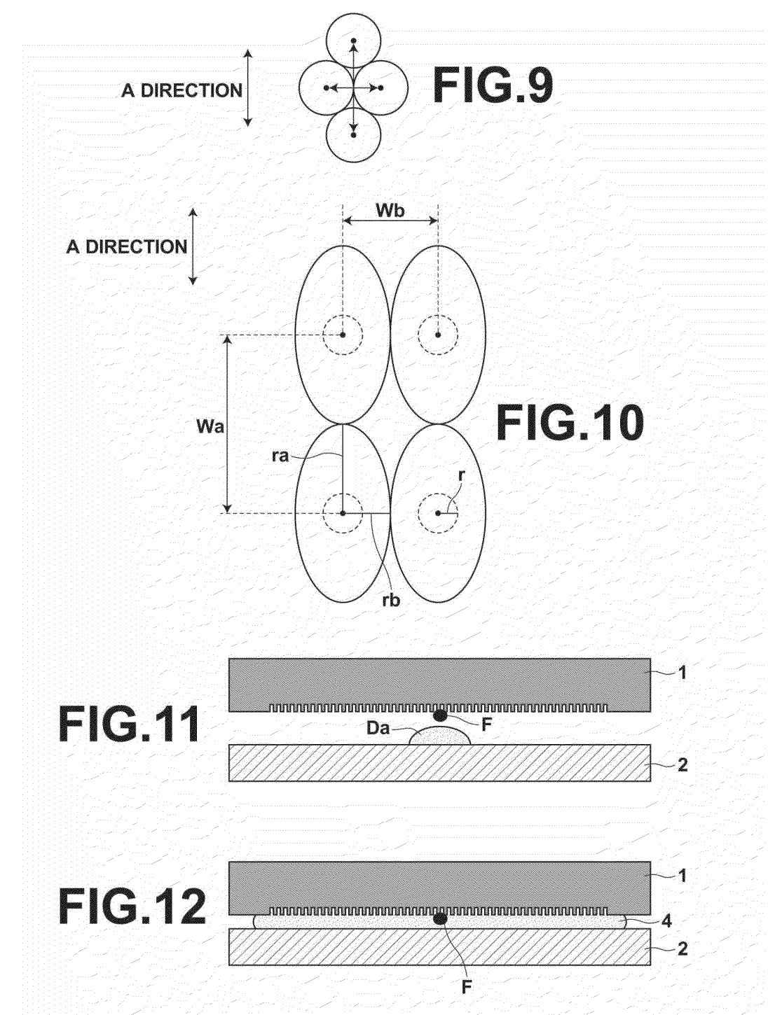

The reason why the lower limit of the value of the ratio Wa/Wb is set to 1.8 is as follows. In the case that circular droplets are closely packed and arranged as illustrated in FIG. 9, the space between droplets Wa in the A direction is approximately 1.73 times the space between droplets Wb in the B direction. Therefore, the droplets can be utilized more efficiently incases that the droplets spread into elliptical shapes, by setting the value of Wa/Wb to be a value greater than 1.73.

Meanwhile, the reason why the upper limit of the value of the ratio Wa/Wb is set to 0.52V^{1/3}/d is because actual spreading of the droplets in the A direction is limited by the average volume V of each droplet and the desired average thickness d of the resist film. Specifically, this value is derived as described below.

As illustrated in FIG. 10, it is preferable for elliptical droplets to spread via a state in which they simultaneously contact other elliptical droplets adjacent thereto in both the A direction (the direction of the long axes) and the B direction (the direction of the short axes) as the shapes of the spreading droplets approximate ellipses, to minimize overlapping portions of the spread droplets when determining the droplet arrangement. This means that it is preferable for the value of Wa/Wb to be the same as a ratio ra/rb between the radius ra of the ellipses in the direction of the long axes and the radius rb of the ellipses in the direction of the short axes. The range of values for Wa/Wb is determined by the range of possible values for ra/rb.

Therefore, what the possible values for ra/rb are in the case that the volume of each coated droplet is V and the desired average thickness of the resist film is d will be described hereinbelow.

First, V=π·ra·rb·d, and therefore, the following Formula (2) holds true.

$$\frac{ra}{rb} = \frac{V}{{π ( rb )}^{2} d} \qquad ( 2 )$$

Generally, the radius rb of the short axis and the radius r of a droplet contact surface prior to spreading (the radius of a circle that approximates the contact surface between the droplet prior to spreading and the substrate) have the relationship rb≧r (rb=r is for cases in which the droplet does not spread in the B direction). Therefore, the possible range of values for ra/rb can be expressed by the following Formula (3).

$$\frac{ra}{rb} \leq \frac{V}{π {r}^{2} d} \qquad ( 3 )$$

Meanwhile, the radius r of the droplet contact surface prior to spreading can be expressed by the following Formula (4), using the volume V of the droplet and a contact angle θ.

$$r = \sqrt{\frac{V {sin}^{3} θ}{π [ ( {cos}^{3} θ ) / 3 - cos θ + 2 / 3 ]}} \qquad ( 4 )$$

By substituting Formula (4) into Formula (3), Formula (5) below is obtained, and then Formula (6) is applied to obtain Formula (7).

$$\begin{matrix}\frac{ra}{rb} \leq \frac{1}{π } {\{ \frac{{sin}^{3} θ}{π [ ( {cos}^{3} θ ) / 3 - cos θ + 2 / 3 ]} \}}^{- 2 / 3} \frac{{V}^{1 / 3}}{d} & ( 5 ) \\ F ( θ ) = \frac{1}{π} {\{ \frac{{sin}^{3} θ}{π [ ( {cos}^{3} θ ) / 3 - cos θ + 2 / 3 ]} \}}^{- 2 / 3} & ( 6 ) \\ \frac{ra}{rb} \leq F ( θ ) \frac{{V}^{1 / 3}}{d} & ( 7 )\end{matrix}$$

Here, F(θ) in Formula (6) is a function that depends only on the contact angle θ. Generally, it is preferable for the contact angle θ to be small, considering close contact properties between the droplet and the substrate. The contact angle θ is set at least to be within a range from 0°<θ≦90°, preferably within a range from 0°<θ≦30°, and more preferably within a range from 0°<θ≦10°. The following Formula (8) is obtained by taking the facts that F(θ) is a monotonously increasing function in the case that 0°<θ≦90° and 0<F(θ)≦0.52 into consideration.

$$\frac{ra}{rb} \leq 0.52 \frac{{V}^{1 / 3}}{d} \qquad ( 8 )$$

The upper limit of the value of Wa/Wb was set to 0.52V^{1/3}/d for the reason described above.

### (Contact Step Between Mold and Curable Composition)

The removal efficiency with respect to the foreign particles F and the amount of residual gas is reduced by pressing the mold 1 against the substrate 2 after depressurizing the atmosphere between the mold and the substrate, or by causing the atmosphere between the mold and the substrate to be a vacuum. However, there is a possibility that the curable composition will volatilize before curing in a vacuum environment, causing difficulties in maintaining a uniform film thickness. Therefore, it is preferable to reduce the amount of residual gas by causing the atmosphere between the substrate and the mold to be an He atmosphere or a depressurized He atmosphere. He passes through the quartz substrate, and therefore the amount of residual gas (He) will gradually decrease. As the passage of He through the quartz substrate takes time, it is more preferable for the depressurized He atmosphere to be employed. It is preferable for the pressure of the depressurized He atmosphere to be within a range from 1 kPa to 90 kPa, and more preferably a range from 1 kPa to 10 kPa.

The mold and the substrate coated with the curable composition are caused to contact each other after they are positioned to have a predetermined positional relationship (FIG. 11). It is preferable for alignment marks to be employed to perform the positioning operation. The alignment marks are formed by patterns of protrusions and recesses which can be detected by an optical microscope or by the Moire interference technique. The positioning accuracy is preferably 10 μm or less, and more preferably 1 μm or less. If the positioning accuracy is poor, the positions of the droplets and the foreign particles will not be aligned, and the foreign particles will not be completely enveloped in the curable composition film.

Alternatively, a region at which the photocurable composition is thickly coated may be caused to contact the foreign particles, while observing the foreign particles adhered to the mold or the substrate, which may be transparent.

In the present invention, it is preferable for the foreign particles to be irradiated with ultrasonic waves through the mold and/or the substrate after the pattern of protrusions and recesses is pressed against the surface on which the curable composition is coated and before the curable composition is cured. Further, it is preferable for the mold and/or the substrate to be heated after the pattern of protrusions and recesses is pressed against the surface on which the photocurable composition is coated and before the photocurable composition is cured. Thereby, the curable composition can more effectively permeate the interior of the foreign particles and the portion of the mold to which the foreign particles is adhered, improving the removal efficiency with respect to the foreign particles.

### (Mold Pressing Step)

The at least droplet Da and the plurality of droplets Db spread by the mold 1 being pressed against the curable composition, to form the curable composition film 4 (FIG. 12).

The mold is pressed against the substrate at a pressure within a range from 100 kPa to 10 MPa. The flow of the curable composition is promoted, the residual gas is compressed, the residual gas dissolves into the photocuring resin, and the passage of He through the quartz substrate is promoted as the pressure is greater. However, if the pressure is excessive, there is a possibility that the mold and the substrate will be damaged if a foreign object is interposed between the mold and the substrate when the mold contacts the substrate. Accordingly, it is preferable for the pressure to be within a range from 100 kPa to 10 MPa, more preferably within a range from 100 kPa to 5 MPa, and most preferably within a range from 100 kPa to 1 MPa. The reason why the lower limit of the pressure is set to 100 kPa is that in the case that the space between the mold and the substrate is filled with liquid when performing imprinting within the atmosphere, the space between the mold and the substrate is pressurized by atmospheric pressure (approximately 101 kPa).

### (Mold Release Step)

After the mold 1 is pressed against the substrate 2 and the curable composition film 4 is formed, the mold is separated from the photocuring resin film. As an example of a separating method, the outer edge portion of one of the mold and the substrate may be held, while the rear surface of the other of the mold and the substrate is held by vacuum suction, and the held portion of the outer edge or the held portion of the rear surface is relatively moved in a direction opposite the pressing direction.

Hereinafter, an example of the present invention will be described.

### Example

### Production of Mold

First, a Si substrate was coated with a photoresist liquid having PMMA (polymethyl methacrylate) as a main component by the spin coat method, to form a photoresist layer. Thereafter, an electron beam, which was modulated according to a pattern having a line width of 100 nm and a pitch of 200 nm, was scanned and irradiated onto the photoresist layer of the Si substrate on an XY stage, to expose a straight linear pattern of protrusions and recesses within a 10 mm square range of the photoresist layer. In addition, cruciform patterns, in which lines having line widths of 10 μm and lengths of 50 μm intersect each other, were exposed at the exteriors of the four corners of the 10 mm square region.

Thereafter, the photoresist layer underwent a development process and the exposed portions were removed. Finally, selective etching was performed to a depth of 80 nm by RIE using the photoresist layer, from which the exposed portions were removed, as a mask, to obtain a first Si mold having the concentric pattern.

As a result of performing a great number of imprinting operations using the mold, a plurality of foreign particles became adhered onto the mold.

### (Photocurable Composition)

A photocurable composition A containing the compound represented by Chemical Formula (1) at 48% by weight, Aronix M220 at 48% by weight, IRGACURE 379 at 3% by weight, and the compound represented by Chemical Formula (2) at 1% by weight was prepared. In addition, a photocurable composition B containing the compound represented by Chemical Formula (1) at 96% by weight, IRGACURE 379 at 2% by weight, the compound represented by Chemical Formula (2) at 1% by weight, and KBM-5103 (by Shin-Etsu Chemical co., Ltd.) at 1% by weight was prepared. The photocurable composition B contains KBM-5103, which has an alkoxysilane group as a functional group that reacts with the surfaces of inorganic foreign particles, as a monomer compound.

### (Substrate)

A 0.525 mm thick quartz substrate was utilized as a substrate. Cruciform alignment marks having the same dimensions as those of the mold were formed on the quartz substrate at positions corresponding to those of the alignment marks of the mold. The surface of the quartz substrate was processed with KBM-5103, which is a silane coupling agent having superior close contact properties with respect to the photocurable composition A and the photocurable composition B. The KBM-5103 was diluted to 1% by weight using PGMEA (Propylene Glycol Monomethyl Ether Acetate), and coated on the surface of the substrate by the spin coat method. Thereafter, the coated substrate was annealed for 20 minutes at 120° C. on a hot plate, causing the silane coupling agent to bond to the surface of the substrate.

### (Detection of Foreign Particles)

A commercially available laser microscope having an XY stage capable of measuring lengths was utilized to detect foreign particles on the mold. The positional coordinates of the foreign particles were obtained as relative coordinates (aₙ, bₙ) on a coordinate plane having one of the alignment marks as the origin. n is a variable assigned to each of a plurality of foreign particles. In addition, shape information of the pieces of the foreign particles was obtained as occupied areas S and heights h by three dimensional measurements.

### (Photocurable Composition Coating Step)

DMP-2831, which is an ink jet printer of the piezoelectric type by FUJIFILM Dimatix, was utilized. DMC-11610, which is a dedicated 10 pl head, was utilized as an ink jet head. Ink expelling conditions were set and adjusted in advance such that the droplet amount became predetermined values. A droplet arrangement density was calculated from the volume of recesses within a predetermined region such that the film thickness will be approximately 10 nm, and a droplet arrangement pattern constituted by square lattices having lattice intervals of 450 μm was produced. Next, the droplet arrangement pattern was corrected such that at least one droplet would be arranged at positions (−aₙ, bₙ), which are the coordinates of the foreign particles corresponding positions on a coordinate system having the alignment mark on the substrate corresponding to the alignment mark which was used as the origin during detection of the foreign particles as its origin. Further, the droplet arrangement was corrected such that the volume of the total droplet amount of the at least one droplet arranged within a region having each foreign particle as its center and a radius r became V, and such that the area of the substrate occupied by the at least droplet became greater than S. At this time, the volume of a single droplet may be V, or the total volume of two or more droplets may be V.

Note that V and S satisfy the following conditions:

V=πr²h

100S≧πr²≧S

### (Mold Pressing Step)

The mold and the quartz substrate were caused to approach each other such that the gap therebetween was 0.1 mm or less. Then, positioning was performed from the back surface of the quartz substrate such that the alignment marks of the substrate and the alignment marks of the mold were aligned.

The space between the mold and the quartz substrate was replaced with a gas which is 99% He by volume or greater. Then, depressurization was performed to 20 kPa, to form a depressurized He environment. The foreign particles were caused to contact the droplets under depressurized He conditions. Following contact, ultrasonic waves having a frequency of 100 kHz or greater were irradiated in a state in which the mold was heated to 40 degrees Celsius, to cause the photocurable composition to effectively permeate the interiors of the foreign particles, and the portions of the mold to which the foreign particles were adhered, thereby improving the removal efficiency with respect to the foreign particles.

Pressure of 1 MPa was applied for one minute, and ultraviolet light including a wavelength of 360 nm was irradiated at a dosage of 300 mJ/cm², to cure the photocuring resin.

### (Mold Release Step)

The outer edge portions of the substrate and the mold were mechanically held or the rear surfaces of the substrate and the mold were held by suction. In this state, the substrate or the mold was relatively moved in a direction opposite the pressing direction, to release and separate the mold.

### Comparative Example

Imprinting was performed in the same manner as in the Example, except that droplets were arranged as square lattices having lattice intervals of 450 μm without taking the foreign particle adhered positions into consideration, and that the mold and the photocurable composition were caused to contact each other without depressurization following replacement of gas with He.

### <Results>

Molds, which were cleaned by the method of the Example and the method of the Comparable Example, were each inspected. The plurality of coordinates at which foreign particles were present on each mold were observed by a laser microscope. As a result, it was confirmed that the method of the present invention more effectively removed the foreign particles from the mold.

What is claimed is:

1. A method for removing foreign matter adhered to a fine pattern of protrusions and recesses of a mold having the pattern of protrusions and recesses on a surface thereof, by causing the foreign matter to adhere to a curable composition coated on a substrate, comprising:
detecting a position on the mold at which the foreign matter is present to obtain adhered position information related to adhered position of the foreign matter;
generating corresponding position information related to a position on the substrate that corresponds to the position at which the foreign matter is present when the pattern of protrusions and recesses and a surface of the substrate on which the curable composition is coated face each other and undergo a predetermined positioning operation, based on the adhered position information;
arranging at least one droplet of the curable composition at the position of the substrate corresponding to the position at which the foreign matter is present, based on the corresponding position information;
pressing the mold against the curable composition in a state in which the pattern of protrusions and recesses and the surface of the substrate on which the composition is coated face each other while administering the predetermined positioning operation;
curing the curable composition; and
separating the mold from the cured composition.

2. A method for removing foreign matter as defined in claim 1, further comprising:
measuring shape of the foreign matter to obtain shape information related to the shape of the foreign matter; and
increasing or decreasing total amount of the at least one droplet based on the shape information.

3. A method for removing foreign matter as defined in claim 2, wherein:
the total amount of the at least one droplet is increased or decreased by increasing or decreasing amount of the curable composition per droplet.

4. A method for removing foreign matter as defined in claim 2, wherein:
the total amount of the at least one droplet is increased or decreased by increasing or decreasing droplet arranging density of the at least one droplet.

5. A method for removing foreign matter as defined in claim 1, wherein:
the foreign matter is formed by an organic material; and
the curable composition contains a polymerizable compound having a molecular weight of 1000 or less.

6. A method for removing foreign matter as defined in claim 1, wherein:
the foreign matter is formed by an inorganic material; and
the curable composition contains a polymerizable compound having a functional group which is reactive with surface of the foreign matter.

7. A method for removing foreign matter as defined in claim 6, wherein:
the curable composition contains 10% by weight or greater of a polyfunctional polymerizable compound having two or more of the functional groups.

8. A method for removing foreign matter as defined in claim 1, wherein:
the foreign matter is irradiated with ultrasonic waves after the pattern of protrusions and recesses is pressed against the surface on which the curable composition is coated and before the curable composition is cured.

9. A method for removing foreign matter as defined in claim 1, wherein:
the curable composition is a photocurable composition; and
the mold and/or the substrate is heated after the pattern of protrusions and recesses is pressed against the surface on which the photocurable composition is coated and before the photocurable composition is cured.

10. A method for removing foreign matter as defined in claim 1, wherein:
a space between the mold and the substrate is depressurized.

11. A method for removing foreign matter as defined in claim 1, wherein:
a plurality of droplets of the curable composition are arranged on a region of the substrate corresponding to the pattern of protrusions and recesses such that a curable composition film is formed on entirety of the region of the substrate without incomplete filling defects caused by gas bubbles when the pattern of protrusions and recesses is pressed against the surface of the substrate on which the curable composition is coated; and
the region of the substrate corresponding to the pattern of protrusions and recesses is a region that corresponds to the pattern of protrusions and recesses when the pattern of protrusions and recesses and the surface of the substrate on which the composition is coated face each other and undergo the predetermined positioning operation.

12. A method for removing foreign matter as defined in claim 11, wherein:
the pattern of protrusions and recesses is a linear pattern of protrusions and recesses constituted by linear protrusions and linear recesses; and
the plurality of droplets are coated on the substrate such that spaces among the droplets in an A direction substantially parallel to direction of lines of the linear pattern of protrusions and recesses are longer than spaces among the droplets in a B direction substantially perpendicular to the A direction.

13. A method for removing foreign matter as defined in claim 12, wherein:
a ratio Wa/Wb between an average space Wa between the droplets in the direction A and an average space Wb between the droplets in the direction B satisfies the following inequality 1, in which V represents average volume of each of the coated droplets, and d represents average thickness of the curable composition film.
1.8≦Wa/Wb≦0.52V^{1/3}/d

14. A method for removing foreign matter as defined in claim 1, wherein:
the method by which the at least one droplet is arranged is the ink jet method.
